(19) United States
(12) Patent Application Publication
(10) Pub. No.: US 2007/0055185 A1
(43) Pub. Date: Mar. 8, 2007

(54) Dynamic motion therapy apparatus having a treatment feedback indicator

(75) Inventors: Titi Trandafir, S. Plainfield, NJ (US); Roger J. Talish, Hillsborough, NJ (US); Kenneth Urgovitch JR., Montague, NJ (US); Donald E. Krompasick, Bethlehem, PA (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: Juvent Inc., Somerset, NJ (US)

(21) Appl. No.: 11/487,677

(22) Filed: Jul. 17, 2006

Related U.S. Application Data
(63) Continuation-in-part of application No. 11/369,611, filed on Mar. 6, 2006.
(63) Continuation-in-part of application No. 11/388,286, filed on Mar. 24, 2006.
(60) Provisional application No. 60/659,159, filed on Mar. 7, 2005.
(60) Provisional application No. 60/665,013, filed on Mar. 24, 2005.
(60) Provisional application No. 60/702,815, filed on Jul. 27, 2005.
(60) Provisional application No. 60/702,735, filed on Jul. 27, 2005.

(51) Int. Cl. A61H 7/00

(52) U.S. Cl. 601/90; 601/84; 601/93

(57) ABSTRACT

An apparatus and method for providing treatment feedback relating to a patient undergoing therapeutic treatment of tissue during dynamic motion therapy are provided. The apparatus includes a platform configured to support a body of the patient; an oscillator connected to the platform and configured to impart an oscillating force at a predetermined frequency on the platform for transmitting mechanical vibration energy through the patient's body; and a processing device in operable communication with the platform for processing data related to the therapeutic treatment and for determining the amount of mechanical vibration energy transmitting through the patient's body. The apparatus further includes a treatment feedback indicator for indicating (e.g., displaying) the amount of mechanical vibration energy transmitting through the patient's body.

### PRIORITY

The present application is a Continuation-In-Part patent application of a U.S. patent application filed on Mar. 6, 2006 titled “Supplemental Support Structures Adapted to Receive a Non-invasive Dynamic Motion Therapy Device” and assigned U.S. patent application Ser. No. 11/369,611; the contents of which are hereby incorporated by reference. U.S. patent application Ser. No. 11/369,611 claims priority from a U.S. Provisional Application filed on Mar. 7, 2005 and assigned U.S. Provisional Application No. 60/659,159; the contents of which are hereby incorporated by reference.

The present application is also a Continuation-In-Part patent application of a U.S. patent application filed on Mar. 24, 2006 titled “Apparatus and Method for Monitoring and Controlling the Transmissibility of Mechanical Vibration Energy During Dynamic Motion Therapy” and assigned U.S. patent application Ser. No. 11/388,286; the contents of which are hereby incorporated by reference. U.S. patent application Ser. No. 11/388,286 claims priority from a U.S. Provisional Application filed on Mar. 24, 2005 and assigned U.S. Provisional Application No. 60/665,013; the contents of which are hereby incorporated by reference.

The present application further claims the benefit of and priority to U.S. Provisional Application filed on Jul. 27, 2005 titled “Method and Apparatus for Monitoring Patient Compliance During Dynamic Motion Therapy” and assigned U.S. Provisional Application Ser. No. 60/702,815; the contents of which are hereby incorporated by reference. Additionally, the present application claims the benefit of and priority to U.S. Provisional Application filed on Jul. 27, 2005 titled “Dynamic Motion Therapy Apparatus Having a Treatment Feedback Indicator” and assigned U.S. Provisional Application Ser. No. 60/702,735; the contents of which are hereby incorporated by reference.

### CROSS-REFERENCE TO RELATED PATENTS

The present application is related to U.S. Pat. Nos. 6,843,776 and 6,884,227, the contents of which are hereby incorporated by reference.

### BACKGROUND

1. Technical Field

The present disclosure generally relates to the field of stimulating tissue growth and healing, and more particularly to an apparatus and method for monitoring and controlling the transmissibility of mechanical vibration energy during dynamic motion therapy. More specifically, the present disclosure relates to a dynamic motion therapy apparatus having a treatment feedback indicator for providing treatment feedback relating to a patient undergoing treatment of damaged tissues, bone fractures, osteopenia, osteoporosis, or other tissue conditions, as well as postural instability, using dynamic motion therapy and mechanical impedance methods. In particular, the treatment feedback indicates the percentage of mechanical vibration energy transmitting through the patient during treatment.

2. Background of the Related Art

When damaged, tissues in a human body such as connective tissues, ligaments, bones, etc. all require time to heal. Some tissues, such as a bone fracture in a human body, require relatively longer periods of time to heal. Typically, a fractured bone must be set and then the bone can be stabilized within a cast, splint or similar type of apparatus. This type of treatment allows the natural healing process to begin. However, the healing process for a bone fracture in the human body may take several weeks and may vary depending upon the location of the bone fracture, the age of the patient, the overall general health of the patient, and other factors that are patient-dependent. Depending upon the location of the fracture, the area of the bone fracture or even the patient may have to be immobilized to encourage complete healing of the bone fracture. Immobilization of the patient and/or bone fracture may decrease the number of physical activities the patient is able to perform, which may have other adverse health consequences. Osteopenia, which is a loss of bone mass, can arise from a decrease in muscle activity, which may occur as the result of a bone fracture, bed rest, fracture immobilization, joint reconstruction, arthritis, and the like. However, this effect can be slowed, stopped, and even reversed by reproducing some of the effects of muscle use on the bone. This typically involves some application or simulation of the effects of mechanical stress on the bone.

Promoting bone growth is also important in treating bone fractures, and in the successful implantation of medical prostheses, such as those commonly known as “artificial” hips, knees, vertebral discs, and the like, where it is desired to promote bony ingrowth into the surface of the prosthesis to stabilize and secure it. Numerous different techniques have been developed to reduce the loss of bone mass. For example, it has been proposed to treat bone fractures by application of electrical voltage or current signals (e.g., U.S. Pat. Nos. 4,105,017; 4,266,532; 4,266,533, or 4,315,503). It has also been proposed to apply magnetic fields to stimulate healing of bone fractures (e.g., U.S. Pat. No. 3,890,953). Application of ultrasound to promoting tissue growth has also been disclosed (e.g., U.S. Pat. No. 4,530,360).

While many suggested techniques for applying or simulating mechanical loads on bone to promote growth involve the use of low frequency, high magnitude loads to the bone, this has been found to be unnecessary, and possibly also detrimental to bone maintenance. For instance, high impact loading, which is sometimes suggested to achieve a desired high peak strain, can result in fracture, defeating the purpose of the treatment.

It is also known in the art that low level, high frequency stress can be applied to bone, and that this will result in advantageous promotion of bone growth. One technique for achieving this type of stress is disclosed, e.g., in U.S. Pat. Nos. 5,103,806; 5,191,880; 5,273,028; 5,376,065; 5,997,490; and 6,234,975, the entire contents of each of which are incorporated herein by reference. In this technique (referred to as dynamic motion therapy), the patient is supported by an oscillating platform apparatus that can be actuated to oscillate vertically, so that resonant vibrations caused by the oscillation of the platform, together with acceleration brought about by the body weight of the patient, provides stress levels in a frequency range sufficient to prevent or reduce bone loss and enhance new bone formation. The peak-to-peak vertical displacement of the platform oscillation may be as little as 2 μm.

However, these systems and associated methods often depend on an arrangement whereby the operator or user must measure the weight of the patient and make adjustments to the frequency of oscillation to achieve the desired therapeutic effect. U.S. Pat. No. 6,843,776 discloses an oscillating platform apparatus that automatically measures the weight of the patient and adjusts characteristics of the oscillation force as a function of the measured weight, to therapeutically treat damaged tissues, bone fractures, osteopenia, osteoporosis, or other tissue conditions.

It is also known in the art that the application of low level, high frequency stress is effective in treating postural instability. A method of using resonant vibrations caused by the oscillation of a vibration table or unstable vibrating platform for treating postural instability is described in U.S. Pat. No. 6,607,497 B2; the entire contents of which are incorporated herein by reference. The method includes the steps of (a) providing a non-invasive dynamic therapy apparatus having a vibration table with a non-rigidly supported platform; (b) permitting the patient to rest on the non-rigidly supported platform for a predetermined period of time; and (c) repeating the steps (a) and (b) over a predetermined treatment duration. Step (b) includes the steps of (b1) measuring a vibrational response of the patient's musculoskeletal system using a vibration measurement device; (b2) performing a frequency decomposition of the vibrational response to quantify the vibrational response into specific vibrational spectra; and (b3) analyzing the vibrational spectra to evaluate at least postural stability.

The method described in U.S. Pat. No. 6,607,497 B2 entails the patient standing on the vibration table or the unstable vibrating platform. The patient is then exposed to a vibrational stimulus by the unstable vibrating platform. The unstable vibrating platform causes a vibrational perturbation of the patient's neuro-sensory control system. The vibrational perturbation causes signals to be generated within at least one of the patient's muscles to create a measurable response from the musculoskeletal system. These steps are repeated over a predetermined treatment duration for approximately ten minutes a day in an effort to improve the postural stability of the patient.

The patient undergoing vibrational treatment for treating postural instability and/or the promotion of bone growth, as described above, may experience a level of discomfort due to whole-body vibration acceleration. The level of discomfort caused by vibration acceleration depends on the vibration frequency, the vibration direction, the point of contact with the body, and the duration of the vibration exposure. It is desirable to monitor at least one mechanical response of the body during vibrational treatment in an effort to control the at least one mechanical response to influence comfort level, as well as to determine patient- and treatment-related characteristics. Two mechanical responses of the body that are often used to describe the manner in which vibration causes the body to move are transmissibility and mechanical impedance.

The transmissibility shows the fraction of the vibration which is transmitted from, say, the vibration table or oscillating platform apparatus to the head of the patient. The transmissibility of the body is highly dependent on vibration frequency, vibration axis and body posture. Vertical vibration on the non-invasive dynamic therapy apparatus causes vibration in several axes at the head; for vertical head motion, the transmissibility tends to be greatest in the approximate range of 3 to 10 Hz.

The mechanical impedance of the body shows the force that is required to make the body move at each frequency. Although the impedance depends on body mass, the vertical impedance of the human body usually shows a resonance at about 5 Hz. The mechanical impedance of the body, including this resonance, has a large effect on the manner in which vibration is transmitted through seats.

As in many other treatment activities, patients undergoing therapeutic treatment of tissue will be more focused and committed when engaged and able to actively view treatment information. Thus, it is desirable to provide a dynamic motion therapy apparatus for providing treatment feedback relating to the transmissibility of the mechanical vibration energy through the patient during dynamic motion therapy.

### SUMMARY

It is an aspect of the present disclosure to provide a dynamic motion therapy apparatus having a treatment feedback indicator for providing treatment feedback relating to a patient undergoing therapeutic treatment of tissue. In particular, the present disclosure provides a treatment feedback indicator for indicating the transmissibility of mechanical vibration energy through the patient's body during dynamic motion therapy.

The present disclosure describes dynamic motion therapy apparatus having a treatment feedback indicator for providing treatment feedback relating to a patient undergoing therapeutic treatment of tissue during dynamic motion therapy. In particular, the treatment feedback indicator indicates the transmissibility of mechanical vibration energy through the patient's body during dynamic motion therapy.

The dynamic motion therapy apparatus includes at least one processing device or digital signal processor for determining and monitoring the weight of the patient's body resting on an oscillating platform. The dynamic (apparent) weight of the patient is continuously in real-time or periodically measured and stored within the digital signal processor to determine the posture of the patient and accordingly, the transmissibility of the mechanical vibration energy through the patient's body as described herein. The posture of the patient and dynamic stiffness of the seat/support structure affects the transmissibility of the mechanical vibration energy through the patient.

The at least one processing device continuously determines a deviation value (how much the patient's apparent weight deviates from the calculated weight (apparent weight minus calculated weight equals the deviation value)) for determining the transmissibility of mechanical vibration energy through the patient's body. The transmissibility of mechanical vibration energy is inversely proportional to the deviation value. The greater the deviation value, the smaller the transmissibility of mechanical vibration energy. Conversely, the smaller the deviation value, the greater the transmissibility of mechanical vibration energy.

If the calculated weight during dynamic motion therapy differs significantly (i.e., more than a predetermined threshold) from the stored apparent weight, the digital signal processor determines that the patient's posture changed and the amount of mechanical vibration energy transmitting through the patient increased or decreased depending on whether the deviation value got smaller from the previous calculation (mechanical vibration energy increased) or got larger from the previous calculation (mechanical vibration energy decreased).

The treatment feedback indicator of the dynamic motion therapy apparatus of the present disclosure generates and displays via a graphical format the amount (e.g., percentage or otherwise) of mechanical vibration energy transmitting through the patient's body. By adjusting the posture of the patient and/or dynamic stiffness of the seat (or other support structure) resting on the oscillating platform, the calculated weight is made to approximate the apparent weight which directly influences the transmissibility of the mechanical vibration energy through the patient's body or support structure, as well as dynamic loading, for maximizing the treatment effects caused by dynamic motion therapy. The change in the amount of mechanical vibration energy transmitting through the patient's body can be visually observed via the graphical format. The graphical format may include a series of bars which are highlighted or other graphical icons which indicate the amount of mechanical vibration energy transmitting through the patient.

The treatment feedback indicator may include auditory feedback where a pre-recorded voice or a number of beeps indicates the amount of mechanical vibration energy transmitting through the patient's body. The treatment feedback indicator may also include a tactile feedback where a tangible signal is transmitted and felt by the patient through a support structure or otherwise.

The apparatus of the present disclosure includes communication circuitry adapted for transmitting patient and treatment related data to a central, remote monitoring station via at least one network, such as the Internet, as described in U.S. Provisional Application Ser. No. 60/702,815. The remote monitoring station is adapted for generating and transmitting a signal to the at least one processing device for controlling at least one treatment parameter, such as, for example, the oscillation frequency of the oscillating platform.

The present disclosure further provides a method for providing treatment feedback relating to a patient undergoing therapeutic treatment of tissue. The method includes the step of supporting a patient's body on a platform; oscillating the platform at an oscillation frequency to impart an oscillating force on the body and to transmit mechanical vibration energy through the body for therapeutically treating the tissue in the body; calculating a weight value relating to the body during oscillation of the body; comparing an apparent weight of the body to the calculated weight value for determining a deviation value indicative of the amount the calculated weight value deviates from the apparent weight; and correlating the deviation value to a transmissibility value indicative of the amount of mechanical vibration energy transmitting through the patient's body.

The method further includes indicating the amount of mechanical vibration energy transmitting through the patient's body via the treatment feedback indicator. The method further includes monitoring the deviation value and generating and transmitting a signal indicative of the deviation value to a remote monitoring station. The method further includes transmitting a control signal from the remote monitoring station to the dynamic motion therapy device for remotely controlling at least one operating parameter of the dynamic motion therapy device.

### BRIEF DESCRIPTION OF THE DRAWINGS

The foregoing features of the present disclosure will become more readily apparent and will be better understood by referring to the following detailed description of preferred embodiments, which are described hereinbelow with reference to the drawings wherein:

FIG. 1 is a perspective view illustrating a non-invasive dynamic motion therapy apparatus having a display unit for displaying treatment feedback in accordance with the present disclosure.

FIG. 2 is a perspective view of an of an ergonomic support structure having an ergonomic hand support structure, a monitor provided on a column having a monitor for displaying treatment feedback and a platform for supporting the non-invasive dynamic motion therapy apparatus in accordance with the present disclosure;

FIG. 3 is a flow chart illustrating a method in accordance with the present disclosure;

FIG. 4 is schematic block diagram of the non-invasive dynamic motion therapy apparatus in accordance with the present disclosure;

FIGS. 5A-5D are schematics of a display screen illustrating graphical formats indicating the transmissibility of mechanical vibration energy through a patient in accordance with the present disclosure; and

FIG. 6 is a top view of an alternative display screen illustrating a graphical format indicating the transmissibility of mechanical vibration energy through a patient in accordance with the present disclosure.

### DETAILED DESCRIPTION

The dynamic motion therapy apparatus and method in accordance with various embodiments of the disclosure provide a treatment feedback indicator capable of providing treatment feedback information relating to a patient undergoing treatment of damaged tissue, bone fractures, osteopenia, osteoporosis, or other tissue conditions, as well as postural instability, using dynamic motion therapy and mechanical impedance methods. Dynamic motion therapy apparatus has an oscillating platform for positioning the patient thereon for providing low displacement, high frequency mechanical loading of bone tissue.

The dynamic motion therapy apparatus includes circuitry and related components including a treatment feedback indicator for providing treatment feedback relating to the transmissibility of mechanical vibration energy during therapeutic treatment of tissue. The treatment feedback indicator may provide visual, tactile, and auditory feedback, or a combination thereof. Apparatus further includes communication circuitry in operative communication with at least one processing device or digital signal processor for transmitting and receiving data from and to a central, remote monitoring station, as described in U.S. Provisional Application Ser. No. 60/702,815.

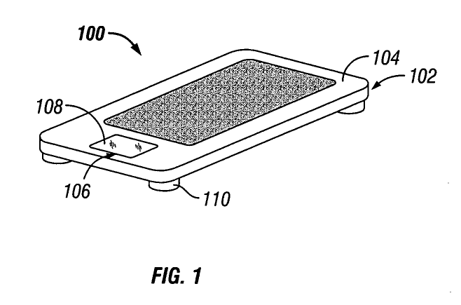

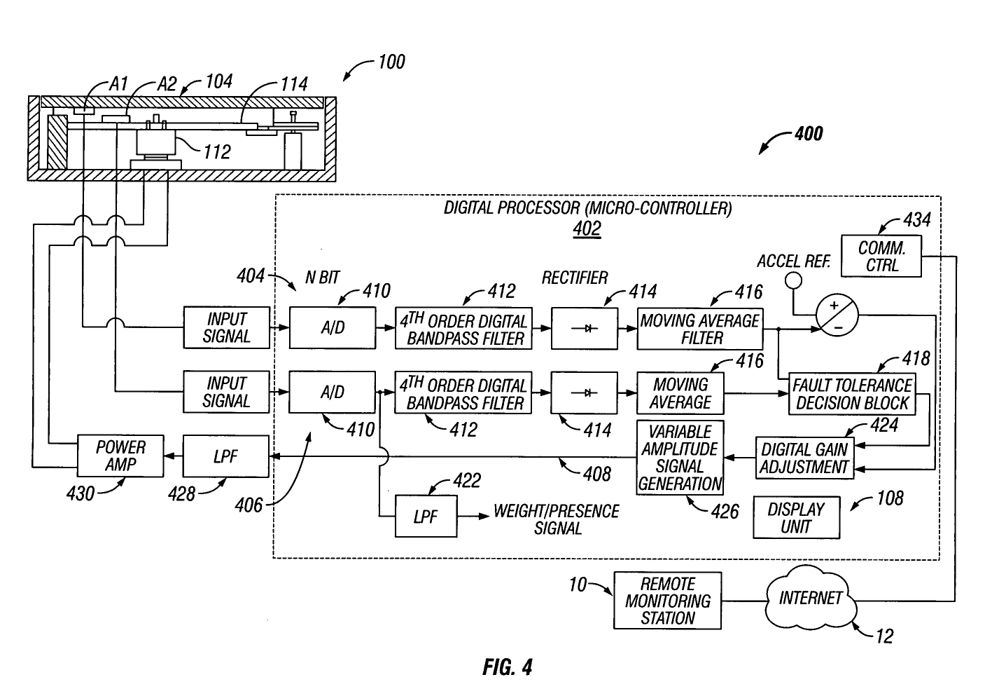

Referring initially to FIG. 1, there is illustrated a perspective view of a non-invasive dynamic motion therapy apparatus in accordance with the present disclosure. The apparatus for providing treatment feedback relating to a patient undergoing therapeutic treatment of tissue is designated generally by reference numeral 100. Apparatus 100 includes a vibration table 102 having a non-rigidly supported platform 104. At least one processing device or digital processor 402 (see FIG. 4), in operative communication with platform 104 for processing data related to the therapeutic treatment. Apparatus 100 further includes a treatment feedback indicator 106 operably connected to the processing device 402 for providing transmissibility information. The treatment feedback indicator 106 or display unit 106 displays visual feedback of transmissibility information of mechanical vibration energy and other information to the patient. Apparatus 100 further includes foot rests 110 for resting the apparatus 100 on a flat surface.

The non-rigidly supported platform 104 rests on motorized spring mechanisms (not shown) which cause the platform 104 to move when they are turned on. Alternatively, the non-rigidly supported platform 104 may rest on a plurality of springs or coils which cause the non-rigidly supported platform 104 to move once a patient stands thereon. Further, the non-rigidly supported platform 104 can include various compliant modalities other than springs (e.g., rubber, elastomers, foams, etc.).

In an alternative embodiment, apparatus 100 includes a platform housed within a housing and having first and second accelerometers, as described in U.S. patent application Ser. No. 11/388,286.

It is envisioned that apparatus 100 may include a communication device in operable communication with the processing device 402 and adapted for transmitting data to a remote monitoring station via at least one network. The communication device is, for example, a cellular phone having a port connector capable of connecting to the communication device for receiving the data via the port connector-communication interface connection and for transmitting said data to the remote monitoring station via a CDA cellular communications network according to the CDMA communications protocol. The communication device may also be, for example, a PDA having a port connector capable of connecting to the communication device for receiving the data via the port connector-communication interface and for transmitting the received data to a PSTN, form where it is transmitted through the Internet according to the Internet protocol, and then to another PSTN connected to the central computer station. The communication device may also operate in accordance with a communication protocol, as is well known in the art, preferably, a TCP/IP protocol. Moreover, the communication device may transmit data via a communication medium, such as, for example, copper wire, phone line connection, internet connection, optical fibre, radio-link, laser, radio or infrared light.

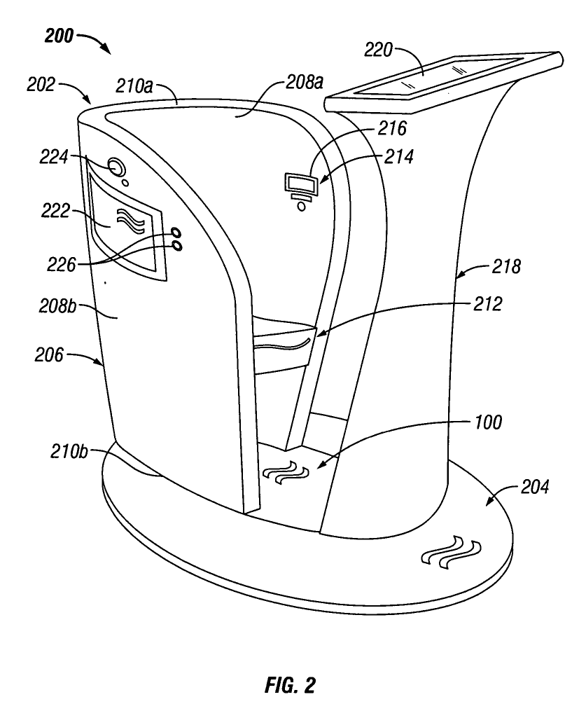

With reference to FIG. 2, apparatus 100 in accordance with the present disclosure is received by a supplemental support structure. In a preferred embodiment of a supplemental support structure, an ergonomic support structure is provided and is designated generally by reference numeral 200. The ergonomic support structure 200 includes an ergonomic hand support structure 202 and a platform 204 for supporting apparatus 100. Apparatus 100 is preferably removable from platform 204.

Ergonomic hand support structure 202 includes a curved structure 206 having inner and outer curved walls 208a, 208b and two curved ends 210a, 210b connecting the two walls 208a, 208b. During vibrational treatment by the non-invasive dynamic motion therapy apparatus 100, the patient grasps the long curved end 210a or lightly touches the inner curved wall 208a.

A patient suffering from a severe case of postural instability or other condition which prevents the patient from standing on the non-rigidly supported platform 100 can be seated on a removable seat 212 and be treated with dynamic motion therapy apparatus 100. Seat 212 is adapted for placement on two opposing surfaces (not shown) defined by the inner curved wall 208a.

Ergonomic support structure 200 further includes an RFID reader 214 for reading an RFID tag provided on the patient for identifying the patient. The RFID reader 214 further includes a display 216 for displaying patient identification data and other data, including video. The RFID reader 214 also includes a processor (not shown) storing patient-related data, such as patient identification data, and treatment data, such as, for example, the dates and duration times of the last five vibrational treatment sessions. The patient-related data for each particular patient is accessed and portions thereof displayed by the display 216 after the patient's corresponding RFID tag is read by the RFID reader 214.

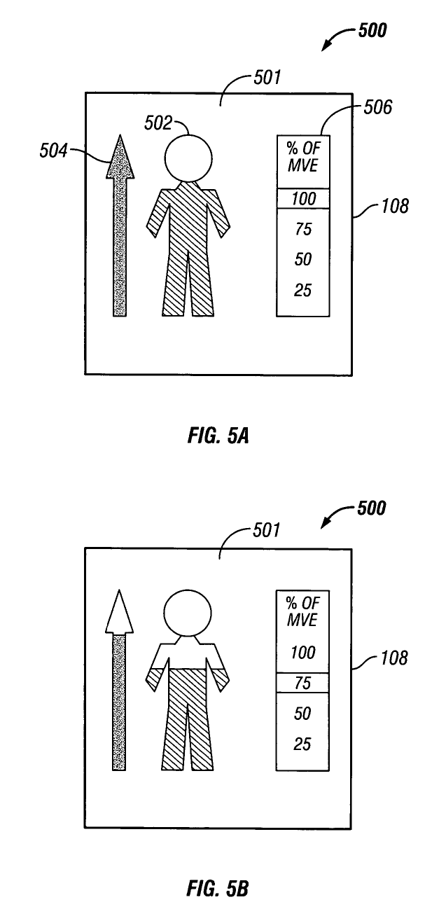

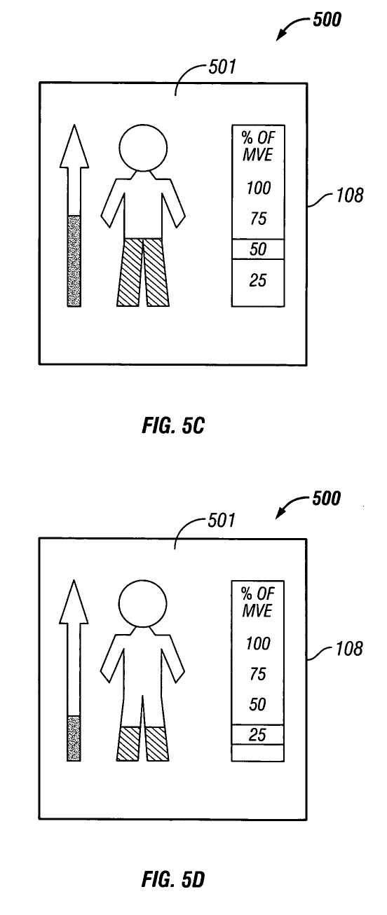

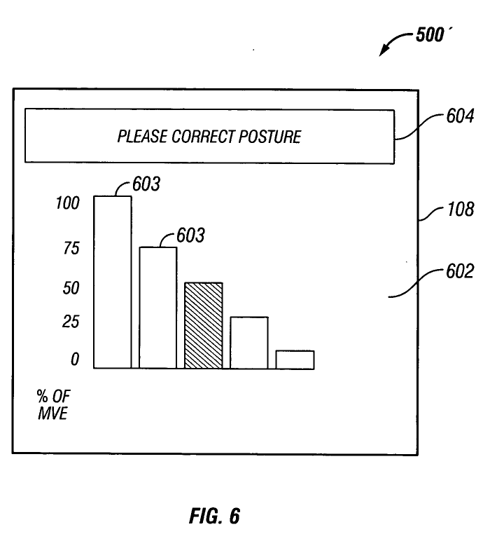

With continued reference to FIG. 2, ergonomic support structure 200 further includes a vertical column 218 having a monitor 220. Monitor 220 displays transmissibility information in similar graphical formats as those shown for example by FIGS. 5A-6. Monitor 220 may also be adapted for displaying patient identification data and other data, such as patient treatment data, including video. Preferably, the monitor 220 is inlaid within the vertical column 218 for enabling the patient to place a book, laptop, etc. on the vertical column 218 without contacting the monitor 220. The vertical column 218 is preferably height adjustable to accommodate patients of differing heights. Monitor 220 is preferably touch-sensitive for controlling the operation of the non-invasive dynamic motion therapy apparatus 100 and performing other functions, such as accessing the Internet, accessing data stored within a memory, etc., by touching the screen of the monitor 220. Another monitor 222 is provided on the outer wall 208b. The outer wall 208b is further provided with a light source 224 above the monitor 222 and control buttons 226.

Ergonomic support structure 200 is provided with circuitry and related components for connecting to a network, such as the Internet, wirelessly and/or non-wirelessly and at least one processor for transmitting and receiving data via the network as known in the art. The data transmitted may include patient monitoring data to determine at a central monitoring station if the patient is complying with a treatment regimen and data to determine whether the patient is properly positioned on the dynamic motion therapy apparatus to obtain optimum treatment effects. The data can include video and/or sensor data obtained by a video camera and/or at least one sensor mounted to the support structures and transmitted via the network to the central monitoring station. The data received can include Internet content and treatment-related data transmitted from the central monitoring station. The data received can include visual and/or audio content for viewing via the monitor 220 and/or listening via earphones connected to audio circuitry embedded within the support structures.

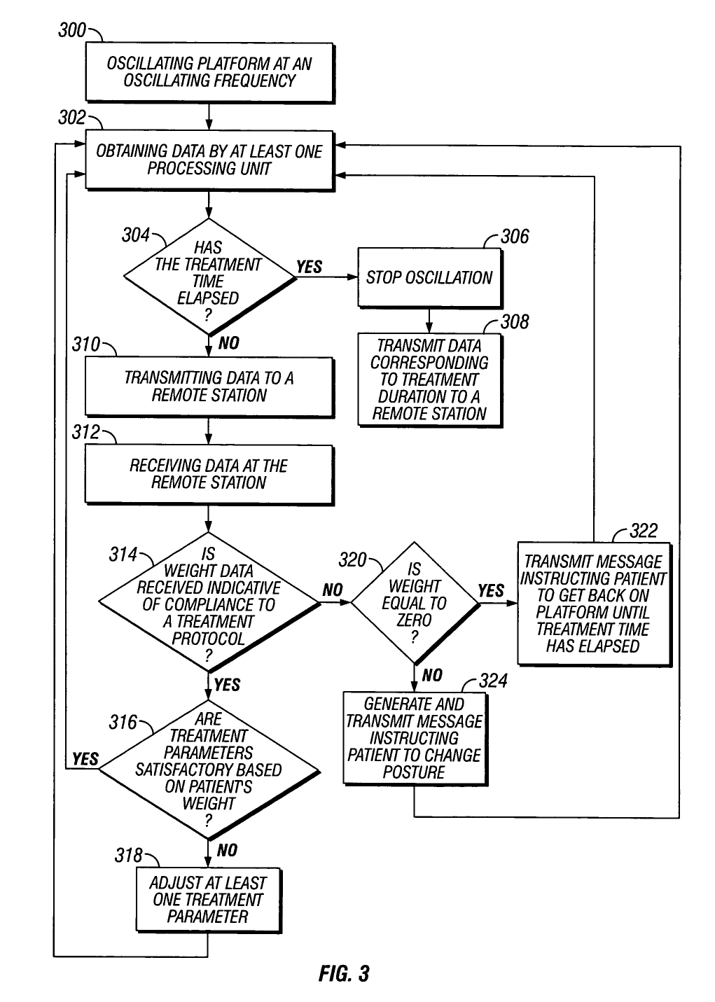

With reference to FIG. 3, there is shown a flow chart illustrating an exemplary method for providing therapeutic treatment of tissue in accordance with the present disclosure. During treatment, a treatment feedback indicator, such as display unit 106 (see FIG. 1), provides treatment feedback as described herein. The method includes the step of supporting the body on a platform 104. Step 300 includes oscillating platform 104 at an oscillation frequency to impart an oscillating force on the body to treat the tissue in the body. Step 302 includes the step of obtaining data via processing device 402. The data is related to at least one treatment parameter during oscillation of the body. The treatment parameter includes, for example, the weight of the patient, the oscillation frequency of platform 104; an amplitude of the oscillating force; and a time interval duration of the treatment. Obtaining data relating to a vibrational response of a musculoskeletal system of the patient is also envisioned.

In one aspect of the present disclosure, the processing device 402 is adapted for monitoring a deviation value indicative of the amount of a calculated weight value deviates from an apparent weight. Predetermined data based on experimental data/knowledge is pre-stored in the at least one processing device. The predetermined data includes a look up table illustrating an inverse relationship between the deviation value and the transmissibility of mechanical vibration energy. That is, the transmissibility of mechanical vibration energy is inversely proportional to the deviation value. More in particular, the greater the deviation value, the smaller the transmissibility of mechanical vibration energy. Conversely, the smaller the deviation value, the greater the transmissibility of mechanical vibration energy. Table 1 illustrates a list of exemplary deviation values (percentages) and their corresponding transmissibility value (percentages) indicating the amount of mechanical vibration energy transmitted through the patient.

TABLE 1

| | TRANSMISSIBILITY OF MECHANICAL |
|---|---|
| DEVIATION VALUE (%) | VIBRATION ENERGY (%) |
| 0 | 100 |
| 25 | 75 |
| 50 | 50 |
| 75 | 25 |
| 100 | 0 |

Following the step of obtaining the data via processing device 402 (Step 302), the system will verify whether the predetermined treatment duration has elapsed. If the treatment duration has elapsed, then the step of oscillating platform 104 is discontinued (Step 306) and data corresponding to treatment duration is transmitted to the remote monitoring station (Step 308). If the treatment duration has not elapsed, then data relating to treatment parameters are transmitted to the remote monitoring station (Step 310). In Step 312, the remote monitoring station receives the data relating to the treatment parameters, i.e., weight of the patient, the oscillation frequency of platform 104, an amplitude of the oscillating force, and a time interval duration of the treatment. The remote monitoring station determines whether data relating to weight is indicative of compliance to a treatment protocol (Step 314).

Since the posture of the patient and dynamic stiffness of the seat/support structure affects the weight of the patient and thus the transmissibility of the mechanical vibration energy through the patient, the processing device 402 determines and monitors the weight of the patient. The weight of the patient is continuously, in real time or periodically, compared to an original stored weight to determine a deviation value (Apparent Weight minus Calculated Weight), i.e., weight data, (Step 314). If the weight data indicates that the calculated weight is equal to zero (Step 320) (that is, the deviation value is substantially equal to the apparent weight), it is determined that the patient has stepped off the platform 104. A message is transmitted to the patient at Step 322 instructing the patient to resume the treatment until the predetermined treatment time has elapsed. The process then proceeds to Step 302.

If weight data indicates that the calculated weight is not equal to zero, i.e. the platform is still supporting the patient, and the deviation value is positive and greater than a predetermined threshold, it is determined that the patient's posture is incorrect and a message is generated and transmitted to the display unit 106 instructing patient to change or correct posture (Step 324). The process then proceeds to Step 302. If the calculated weight does not differ significantly from the original stored weight as determined by the processing device 402, i.e., deviation value is substantially zero, (patient is complying to treatment protocol), then at Step 316 it is determined whether the treatment parameters are satisfactory based on the weight of the patient. If yes, the process then proceeds to Step 302. If no, then at Step 318, at least one treatment parameter, e.g., amplitude of the oscillating force, is adjusted and the process proceeds to Step 302.

The frequency of oscillation or oscillating frequency is not changed during treatment. The apparatus 100 during the initial tune-up performs a self-evaluation (calibration) and does a frequency sweep between 32 and 37 Hz to find the maximum acceleration for the particular user. After the initial tune-up, the apparatus 100 maintains the chosen oscillating frequency for the rest of the treatment duration.

With reference to FIG. 4, there is shown a schematic block diagram of the dynamic motion therapy apparatus 100 in accordance with the disclosure. Schematic block diagram includes at least one processing device or digital processor as described in U.S. patent application Ser. No. 11/388,286. The dynamic motion therapy apparatus 100 includes the platform 104 and two accelerometers A1, A2 for transmitting information to processing device 402. Processing device 402 is preferably a digital signal processor 402 as shown by FIG. 4 having circuitry and programmable instructions stored within a memory and capable of being executed by the digital signal processor 402 for operating the dynamic motion therapy apparatus 100. The digital signal processor 402 includes two incoming data paths 404, 406 having identical components for processing data received from the two accelerometers A1, A2 and one outgoing data path 408 for relaying control or feedback signals to the oscillating actuator 112 for causing vibration of the platform 104 via drive lever 114.

Digital signal processor 402 includes a memory storing a set of programmable instructions capable of being executed by the digital signal processor 402 for operating the components of the two incoming data paths 404, 406 and one outgoing data path 408 for performing the functions described above in accordance with the disclosure, as well as other functions. The set of programmable instructions can also be stored on a computer-readable medium, such as a CD-ROM, diskette, and other magnetic media, and downloaded to the digital signal processor 402.

Each incoming data path includes four major components for processing the incoming data from the two accelerometers A1, A2. The four major components are in order from left to right in FIG. 4 an analog-to-digital (A/D) converter 410, a bandpass filter 412, a rectifier 414, a moving average filter 416, and a fault tolerance decision block 418.

Preferably, the bandpass filter 412 in each incoming data path is a 4^{th} order elliptic bandpass filter which finds the “sweet spot” for each particular patient (this causes the processor to shift the resonance of the dynamic therapy system 100 based on the patient's mass or weight by transmitting a signal to the oscillating actuator 112 to change the frequency of the oscillating force). The digital signal processor 402 processes the polynomial coefficients of the 4^{th} order elliptic bandpass filters by implementing “power of two” coefficients. The processor 402 is programmed to do this instead of performing polynomial multiplication for each coefficient in the polynomial which would require a significantly longer processing time. The processor 402 in accordance with the present disclosure reduces processing time by approximating the polynomial coefficients using the “power of two.” For example, if the coefficient is 3.93215, the processor 402 can perform a quick approximation of the coefficient by approximating the coefficient as follows: 4 1/16+ 3/128− 1/512. It is contemplated that the same method can be used to process the coefficients of the other filters of the processor 402.

The output from the moving average filter 416 of incoming data path 404 is provided to the fault tolerance decision block 418 for determining fault tolerance level and an adder/subtractor block 420 for deciding whether to increase or decrease the gain to maintain the average vibration intensity to a preset value. The output of block 420 is an error signal which determines whether to increase or decrease the vibration level of the oscillating actuator 112.

The output from the adder/subtractor block 420 is the acceleration of the patient and the output from A/D converter 410 of incoming data path 406 is provided to a low-pass filter 422 which outputs a weight/presence signal. The weight/presence signal is used to sense the presence of the patient and to calculate the weight of the patient continuously or periodically using conventional weight/angle equations during dynamic motion therapy.

By determining the weight of the patient during treatment and comparing the weight to the original stored weight as described above, the processor 402 is able to determine whether the patient is compliant with the treatment protocols (e.g., whether patient is resting, standing, etc. on platform 104) and the posture of the patient for determining the transmissibility of the mechanical vibration energy through the patient. The patient can then influence the transmissibility, if necessary (i.e., if the calculated weight indicates poor transmissibility), by shifting or changing his posture accordingly.

The acceleration value of the patient and the output from the fault tolerance decision block 418 are inputs at separate times (since the processor 402 of the dynamic motion therapy apparatus 100 is designed as a real time interrupt driven software system as described below) during operation of the dynamic therapy apparatus 100 to the outgoing data path 408.

The outgoing data path 408 includes four major components for processing control and feedback signals transmitted from the processor 402 to the oscillating actuator 112. The four major components are in order from right to left in FIG. 4 a digital gain adjustment module 424 for performing automatic gain control as described above, a variable amplitude signal generation module 426 for increasing or decreasing the sinusoidal signal driving the oscillating actuator 112, a low-pass filter 428 for filtering the control and feedback signals and a power amplifier 430 for amplifying the control and feedback signals.

The apparatus 100 includes a treatment feedback indicator 500, 500′ which in a preferred embodiment includes display unit 106 for displaying treatment related information (amount of mechanical vibration energy transmitted through the patient) and other information, such as diagnostic information, to the patient, medical professional or other individual. The treatment related information can include the original calculated weight of the patient and the calculated weight of the patient during treatment, the acceleration of the patient, automatic gain control information, level or degree of compliance to the treatment protocols, a transmissibility value indicating or approximating the amount of mechanical vibration energy being transmitted through the patient or support structure-patient during treatment, etc.

The digital signal processor 402 of the dynamic motion therapy apparatus 100 is designed as a real time interrupt driven software system (the apparatus 100 does not have a main loop). A timer interrupt occurs every 1/fs milliseconds. That is, for example, if the apparatus 100 is tuned at 34 Hz, a timer interrupt occurs every 1/34 seconds. A different function occurs during each timer interrupt, such as replenishing or updating the display unit 106, transmitting the control or feedback signals to the oscillating actuator 112, and generating a transmitting a sine wave to the oscillating actuator 112 for automatic gain control (the sine wave is preferably generated and transmitted approximately 500 times per second). It is contemplated that higher priority interrupts are performed first. If there is not interrupt to be performed, the processor 402 goes into an idle mode until there is an interrupt to perform.

The digital signal processor 402 generates the (sinusoidal) signal to the oscillating actuator 112 and processes the acceleration signal received from accelerometer Al using at least one digital bandpass filter 412 with a variable sampling rate during calibration (tuning) of the dynamic motion therapy apparatus 100. In the dynamic motion therapy apparatus 100, the sampling rate and thus the vibration frequency is between 0 and 250 Hz, with the at least one digital bandpass filter 412 adaptively tuned to the current operating frequency. The variable sampling rate is possible due to the interrupt driven software system of the software control loop as described above.

The dynamic therapy apparatus 100 further includes communication circuitry 434 for downloading/uploading data, including software updates, to the processor 402 and for communicating with a central monitoring station via a network, such as the Internet, including receiving Internet content. The communication circuitry 434 can include RS232, USB, parallel and serial ports and associated circuitry, as well as network connection software and circuitry, such as a modem, DSL connection circuitry, etc. Preferably, the process of downloading/uploading data, including software updates, is configured as an interrupt for being performed during a timer interrupt by the dynamic therapy apparatus 100. As shown by FIG. 4, communication circuitry 434 is connected to the central, remote monitoring station 10 via the Internet 12.

The data transmitted from the dynamic motion therapy apparatus 100 to the remote monitoring station can include video and/or sensor data obtained by a video camera and/or at least one sensor mounted to the support structure or the dynamic motion therapy apparatus 100 and transmitted via the network to the central, remote monitoring station.

Patient compliant data (directed to whether the patient is complying to treatment protocols) and other patient- and treatment-related data are preferably stored in the dynamic therapy apparatus 100 for evaluation at a later time or for transmission via the network using the communications circuitry 434 to the central monitoring station for observation. The transmission can also occur in real time during dynamic motion therapy for enabling a medical professional or other observer to transmit data via the network to the patient during the therapy session. The transmitted data can be displayed to the patient on the display unit 106 and/or audibly played via a speaker. The display unit 106 includes a graphic display 108 for providing visual feedback of the amount of mechanical vibration energy transmitted to the patient, wherein the graphic display 108 includes a graphical format, such as, for example, an icon or graph as illustrated in FIGS. 5A-5D.

FIGS. 5A-5D illustrate display unit 106 having a graphical format 501 indicating the transmissibility of mechanical vibration energy through the patient. Icon 502 illustrates an image of a body for graphically illustrating the transmissibility of mechanical vibration energy. For example, when the deviation of the apparent stored weight to the calculated weight is on or about zero, the transmissibility of mechanical vibration energy is 100%, and, as illustrated in FIG. 5A, the icon 502 is highlighted up to the 100% level of bar display 506. Another icon 504 also is highlighted to indicate 100% transmission of the mechanical vibration energy generated by the dynamic motion therapy apparatus 100. As the patient's posture changes from a correct posture to an substantially incorrect posture, the amount of mechanical vibration energy transmitted through the patient changes and is accordingly displayed in sequence by FIGS. 5B to 5D.

With reference to FIG. 6, an alternative embodiment of the graphical format is illustrated and designated by reference numeral 602. The graphical format 602 has a series of bars 603 where one is highlighted at any given time to indicate the amount of mechanical vibration energy being transmitted through the patient at that time. In FIG. 6, the middle bar is highlighted indicating 50% transmission of the mechanical vibration energy. If the leftmost bar is not highlighted, the graphical format 602 automatically displays a message 604 instructing the patient to correct posture. The message can also be relayed by the remote monitoring station as described above. The same message can also be displayed by graphical format 501.

Using the dynamic therapy apparatus 100 and mechanical impedance methods as known in the art, one can predict the transmissibility of the mechanical vibration energy through the patient being supported by a support structure, such as a kneeling chair-type support structure, wheel chair, seat, exercise device, etc., using the dynamic stiffness of the support structure and the apparent mass of the body measured at appropriate vibration magnitudes. The materials, structure, orientation, etc. of the support structure can then be selected and re-designed for maximizing the transmissibility of the mechanical vibration energy through the oscillating platform apparatus-support structure-patient interface in order to maximize the transmissibility of the mechanical vibration energy through the patient. The support structure can in effect be custom designed for each patient for maximizing the transmissibility of the mechanical vibration energy through the patient.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

1. A method for providing treatment feedback relating to a patient undergoing therapeutic treatment of tissue, the method comprising:
supporting a patient's body on a platform;
oscillating the platform at an oscillation frequency to impart an oscillating force on the body and to transmit mechanical vibration energy through the body for therapeutically treating the tissue in the body;
calculating a weight value relating to the body during oscillation of the body;
comparing an apparent weight of the body to the calculated weight value for determining a deviation value indicative of the amount the calculated weight value deviates from the apparent weight;
correlating the deviation value to a transmissibility value indicative of the amount of mechanical vibration energy transmitted through the patient's body; and
indicating the amount of mechanical vibration energy transmitted through the patient's body.

2. The method as recited in claim 1, further comprising determining if a predetermined treatment duration has elapsed, and stopping oscillation of the platform if the predetermined treatment duration has elapsed.

3. The method as recited in claim 1, further comprising transmitting the amount of mechanical vibration energy transmitted through the patient's body to a remote monitoring station.

4. The method as recited in claim 1, further comprising providing a treatment feedback indicator selected from a group consisting of auditory, tactile, and visual treatment feedback indicators for performing the step of indicating the amount of mechanical vibration energy transmitted through the patient's body.

5. The method as recited in claim 4, wherein the visual treatment feedback indicator includes a display for performing the step of indicating via a graphical format the amount of mechanical vibration energy transmitted through the patient's body.

6. The method as recited in claim 1, further comprising determining whether the deviation value is greater than a predetermined threshold, and generating and transmitting a message instructing the patient to correct posture if the deviation value is greater than a predetermined threshold.

7. The method as recited in claim 1, further comprising determining whether the deviation value is substantially equal to the apparent weight, determining if a predetermined treatment duration has elapsed, and generating and transmitting a message instructing the patient to get on the platform if the deviation value is substantially equal to the apparent weight and the predetermined treatment duration has not elapsed.

8. An apparatus for therapeutic treatment of tissue in a body of a patient, the apparatus comprising:
a platform configured to support a body of the patient;
an oscillator operably connected to the platform and configured to oscillate and impart an oscillating force at a predetermined frequency on the platform for transmitting mechanical vibration energy through the patient's body;
at least one processing device in operable communication with the oscillator for processing data related to the therapeutic treatment, correlating a determined value to an amount of mechanical vibration energy transmitted through the patient's body, and controlling the oscillator via at least one control signal; and
an indicator in operable communication with the at least one processing device for indicating the amount of mechanical vibration energy transmitted through the patient's body.

9. The apparatus of claim 8, wherein the determined value is a deviation value indicative of the amount a calculated weight value deviates from an apparent weight of the patient, and wherein the at least one processing device accesses a data structure for correlating the determined value to the amount of mechanical vibration energy transmitted through the patient's body.

10. The apparatus of claim 8, wherein the indicator is selected from the group consisting of auditory, tactile, and visual indicators.

11. The apparatus of claim 10, wherein the visual indicator includes a display for indicating via a graphical format the amount of mechanical vibration energy transmitted through the patient's body.

12. The apparatus of claim 8, further comprising communication circuitry in operative communication with the at least one processing device for transmitting data including the amount of mechanical vibration energy transmitted through the patient's body to a remote monitoring station.

13. The apparatus of claim 12, wherein the remote monitoring station generates and transmits a signal to the at least one processing device for remotely controlling the oscillator.

14. The apparatus of claim 8, wherein the at least one processing device determines if a predetermined treatment duration has elapsed, and stopping oscillation of the oscillator if the predetermined treatment duration has elapsed.

15. The apparatus of claim 8, wherein the at least one processing device determines whether the deviation value is greater than a predetermined threshold, and generates and transmits a message instructing the patient to correct posture if the deviation value is greater than a predetermined threshold.

16. The apparatus of claim 8, wherein the determined value is a deviation value, and wherein the at least one processing device determines whether the deviation value is substantially equal to an apparent weight of the patient, determines if a predetermined treatment duration has elapsed, and generates and transmits a message instructing the patient to get on the platform if the deviation value is substantially equal to the apparent weight and the predetermined treatment duration has not elapsed.

17. A method for providing treatment feedback relating to a patient undergoing therapeutic treatment of tissue, the method comprising:
supporting a patient's body on a platform;
oscillating the platform at an oscillation frequency to impart an oscillating force on the body and to transmit mechanical vibration energy through the body for therapeutically treating the tissue in the body;
calculating a weight value relating to the body during oscillation of the body;
comparing an apparent weight of the body to the calculated weight value for determining a deviation value indicative of the amount the calculated weight value deviates from the apparent weight;
correlating the deviation value to a transmissibility value indicative of the amount of mechanical vibration energy transmitted through the patient's body;
indicating the amount of mechanical vibration energy transmitted through the patient's body; and
determining whether the deviation value is greater than a predetermined threshold, and generating and transmitting a message instructing the patient to correct posture if the deviation value is greater than a predetermined threshold.

18. The method as recited in claim 17, further comprising determining if a predetermined treatment duration has elapsed, and stopping oscillation of the platform if the predetermined treatment duration has elapsed.

19. The method as recited in claim 17, further comprising transmitting the amount of mechanical vibration energy transmitted through the patient's body to a remote monitoring station.

20. The method as recited in claim 17, further comprising providing a treatment feedback indicator selected from a group consisting of auditory, tactile, and visual treatment feedback indicators for performing the step of indicating the amount of mechanical vibration energy transmitted through the patient's body.

21. The method as recited in claim 20, wherein the visual treatment feedback indicator includes a display for performing the step of indicating via a graphical format the amount of mechanical vibration energy transmitted through the patient's body.

22. The method as recited in claim 17, further comprising determining whether the deviation value is substantially equal to the apparent weight, determining if a predetermined treatment duration has elapsed, and generating and transmitting a message instructing the patient to get on the platform if the deviation value is substantially equal to the apparent weight and the predetermined treatment duration has not elapsed.

23. An apparatus for therapeutic treatment of tissue in a body of a patient, the apparatus comprising:
a platform configured to support a body of the patient;
an oscillator operably connected to the platform and configured to oscillate and impart an oscillating force at a predetermined frequency on the platform for transmitting mechanical vibration energy through the patient's body;
at least one processing device in operable communication with the oscillator for processing data related to the therapeutic treatment, correlating a determined value to an amount of mechanical vibration energy transmitted through the patient's body, and controlling the oscillator via at least one control signal; and
an indicator in operable communication with the at least one processing device for indicating the amount of mechanical vibration energy transmitted through the patient's body,
wherein the at least one processing device determines whether the determined value is greater than a predetermined threshold, and generates and transmits a message instructing the patient to correct posture if the determined value is greater than a predetermined threshold.

24. The apparatus of claim 23, wherein the determined value is a deviation value indicative of the amount a calculated weight value deviates from an apparent weight of the patient, and wherein the at least one processing device accesses a data structure for correlating the determined value to the amount of mechanical vibration energy transmitted through the patient's body.

25. The apparatus of claim 23, wherein the indicator is selected from the group consisting of auditory, tactile, and visual indicators.

26. The apparatus of claim 25, wherein the visual indicator includes a display for indicating via a graphical format the amount of mechanical vibration energy transmitted through the patient's body.

27. The apparatus of claim 23, further comprising communication circuitry in operative communication with the at least one processing device for transmitting data including the amount of mechanical vibration energy transmitted through the patient's body to a remote monitoring station.

28. The apparatus of claim 27, wherein the remote monitoring station generates and transmits a signal to the at least one processing device for remotely controlling the oscillator.

29. The apparatus of claim 23, wherein the at least one processing device determines if a predetermined treatment duration has elapsed, and stopping oscillation of the oscillator if the predetermined treatment duration has elapsed.

30. The apparatus of claim 23, wherein the determined value is a deviation value, and wherein the at least one processing device determines whether the deviation value is substantially equal to an apparent weight of the patient, determines if a predetermined treatment duration has elapsed, and generates and transmits a message instructing the patient to get on the platform if the deviation value is substantially equal to the apparent weight and the predetermined treatment duration has not elapsed.
